(19) United States
(12) Patent Application Publication
(10) Pub. No.: US 2024/0119514 A1
(43) Pub. Date: Apr. 11, 2024

(54) PEER-TO-PEER VEHICLE SHARING SYSTEM AND METHOD

(71) Applicant: Ford Global Technologies, LLC, Dearborn, MI (US)

(72) Inventors: Yifan Chen, Ann Arbor, MI (US); Sarah Garrow, Marshall, MI (US)

(73) Assignee: Ford Global Technologies, LLC, Dearborn, MI (US)

(21) Appl. No.: 17/938,781

(22) Filed: Oct. 7, 2022

(51) Int. Cl. G06Q 30/06

(52) U.S. Cl. CPC G06Q 30/0645

(57) ABSTRACT

A peer-to-peer (P2P) vehicle sharing method is disclosed. The method includes receiving a request from a user to rent a vehicle. The request includes a rent time period. The method further includes receiving a plurality of inputs associated with the user. The plurality of inputs includes a vehicle type for the vehicle owned by the user. Responsive to receiving the request and the plurality of inputs, the method includes obtaining a set of available vehicles, and corresponding availability periods associated with the available vehicles. The method further includes determining a rent time period overlap extent with the available vehicles' availability periods. Based on the overlap extent determination and the plurality of inputs, the method includes selecting the rent vehicle from the set of available vehicles, and reserving the rent vehicle for the user.

### TECHNICAL FIELD

The present disclosure relates to a peer-to-peer vehicle sharing system and method.

### BACKGROUND

With the advent of internet and web-based services, rental platforms are growing rapidly across the world. Rental platforms allow sharing or renting of a wide variety of assets, such as vehicles. For instance, peer-to-peer (P2P) vehicle sharing platforms allow users to rent or lease vehicles on a temporary basis. P2P vehicle sharing platforms are beneficial for vehicle owners as they facilitate in generation of additional income, for example, when the vehicle owners are not using their vehicles.

In a conventional vehicle sharing platform, vehicle owners offer their vehicles for rent, and a renter may choose a rent vehicle from the available vehicles that suits their needs. Typically, the renter invest substantial time and effort identifying the rent vehicle on conventional rental vehicle platforms. In addition, identifying the rent vehicle is a time-consuming process, which may be inconvenient for the user.

Some vehicle sharing platforms recommend rent vehicles to the renter, based on renter's location, preferences, and other criteria. While such platforms can simplify the rental process, vehicle utilization may not always be optimal on such platforms. For example, the vehicle owners may not maximize vehicle utilization of their vehicles, and hence optimum revenue generation potential may not be tapped.

Thus, there exists a need in the industry for an enhanced system and method for sharing/renting vehicles, specifically for minimizing the amount to time and effort required for identifying the rent vehicle, and for optimizing vehicle utilization.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 illustrates a block diagram of an example Peer-to-Peer (P2P) vehicle sharing system in accordance with the present disclosure.

FIG. 3 depicts an example embodiment of renting a vehicle in a P2P vehicle sharing system in accordance with the present disclosure.

FIG. 4 depicts a first flow diagram of an example method for selecting a rent vehicle, in accordance with the present disclosure.

FIG. 5 depicts a second flow diagram of an example method for selecting a request for renting a vehicle, in accordance with the present disclosure.

FIG. 6 depicts a third flow diagram of an example method for updating reservation of a vehicle, in accordance with the present disclosure.

FIG. 7 depicts a fourth flow diagram of an example method for updating reservation of a request, in accordance with the present disclosure.

FIG. 8 depicts a fifth flow diagram of an example method for updating reservation of a vehicle, in accordance with the present disclosure.

FIG. 9 depicts a sixth flow diagram of an example method for updating reservation of a request, in accordance with the present disclosure.

### DETAILED DESCRIPTION

### Overview

The present disclosure describes a peer-to-peer (P2P) vehicle sharing platform that may allow vehicle owners to share their vehicles with a plurality of renters. A renter, who may want to rent a vehicle, may raise a rent request on the P2P vehicle sharing platform. In some aspects, the rent request may include a rent time period for which the renter requires the vehicle, a travel location (e.g., a location/city/airport name from where the renter may want to rent the vehicle), and/or the like. Responsive to receiving the rent request, the P2P vehicle sharing platform may identify an available vehicle or a set of available vehicles that may be available during the rent time period. In a scenario, where the P2P vehicle sharing platform identifies more than one available vehicle, the P2P vehicle sharing platform may determine a rent time period overlap extent with availability periods of available vehicles. In some aspects, the P2P vehicle sharing platform may select an available vehicle whose availability period has a maximum overlap extent. The P2P vehicle sharing platform may reserve the selected vehicle for the renter, and may transmit a reservation notification to the renter and the selected vehicle owner.

In some aspects, the P2P vehicle sharing platform may further select and reserve the rent vehicle for the renter, based on a vehicle type associated/owned by the renter. For instance, if the renter owns a “Ford Mach-E”, the P2P vehicle sharing platform may select and reserve a “Ford Mach-E” for the renter.

In further aspects, the P2P vehicle sharing platform may dynamically re-evaluate the rent vehicle reservation based on a receipt of a predefined trigger event. In some aspects, the predefined trigger event may include a new rent request, a new vehicle entry to the set of available vehicles, renter's request withdrawal, and/or rent vehicle withdrawal by the owner. In some aspects, the P2P vehicle sharing platform may replace the rent vehicle with a new vehicle, if the new vehicle is a better match for the renter over the rent vehicle. For example, if the rent time period overlap extent with the new vehicle availability period is greater than the rent time period overlap extent with the rent vehicle availability period, the P2P vehicle sharing platform may replace the rent vehicle with the new vehicle for the renter.

The present disclosure provides a P2P vehicle sharing platform that saves renter's time and effort in selecting the best rent vehicle. In addition, the P2P vehicle sharing platform provides an advantage of improving vehicle utilization, as the rent vehicle selection is based on the rent time period overlap extent and the vehicle availability. Furthermore, the P2P vehicle sharing platform allows vehicle owners to share their vehicles with like-minded renters (e.g., renters who own vehicles of same vehicle type), thereby offering vehicle familiarization and reducing possibility of any inadvertent and/or impact on the condition of the vehicles.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

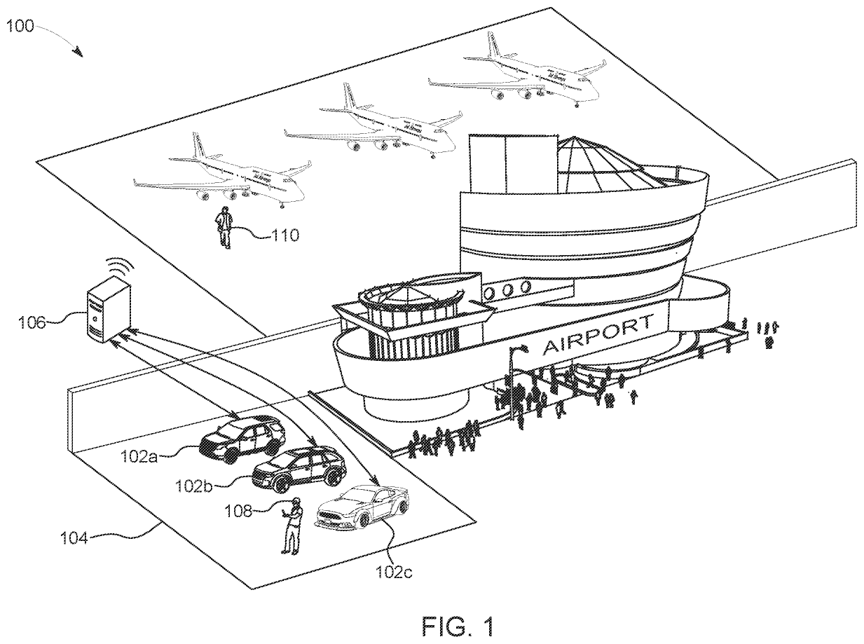

FIG. 1 depicts an example environment 100 in which techniques and structures for providing the systems and methods disclosed herein may be implemented. The environment 100 may include a plurality of vehicles 102a, 102b, 102c (collectively referred to as a plurality of vehicles 102) that may be parked at a public place 104. In one or more aspects, the public place 104 may be a parking lot in an airport (as shown in FIG. 1), a train station, a mall, a public parking space, a private parking space and/or the like. In some aspects, the plurality of vehicles 102 may be registered with a peer-to-peer (P2P) vehicle sharing platform 106. The P2P vehicle sharing platform 106 may be hosted on a server, and may allow vehicle owners to share their vehicles with others. For instance, an owner 108 of a vehicle 102a may be going out of town for a plurality of days. During these days, as the owner 108 may not use the vehicle 102a, the owner 108 may offer the vehicle 102a for rent through the P2P vehicle sharing platform 106 to a renter (for example, a renter 110). In some aspects, the renter 110 may be travelling to the town, and may need a vehicle (e.g., the vehicle 102a) to rent on a temporary basis.

In some aspects, the owner 108 may register (if not already registered) the vehicle 102a on the P2P vehicle sharing platform 106, to offer the vehicle 102a for rent. The owner 108 may register via an owner device (e.g., a mobile phone, a laptop, a desktop computer, a vehicle infotainment system, and/or the like). The owner 108 may provide a plurality of details, such as owner name, social security number, vehicle details, year of vehicle purchase, owner's bank account details, and/or the like, while registering the vehicle 102a. The vehicle details may include, but are not limited to, vehicle type, brand, model number, color, insurance documents, and the like. In some aspects, the owner 108 may upload vehicle pictures and the insurance documents to the P2P vehicle sharing platform 106, while registering the vehicle 102a.

In one or more aspects, the owner 108 may provide details of a time period during which the vehicle 102a may be available for rent, when the owner 108 registers the vehicle 102a with the P2P vehicle sharing platform 106. For instance, the owner 108 may provide the availability period details before (e.g., 15 days in advance) the vehicle 102a becoming available. In a manner similar to the owner 108 registering the vehicle 102a, in accordance with some aspects, the renter 110 may register on the P2P vehicle sharing platform 106. The renter 110 may register via a renter device (e.g., a mobile phone, a laptop, a desktop computer, a vehicle infotainment system, and/or the like). The renter 110 may provide renter details (e.g., renter profile), details of vehicle(s) owned by the renter 110, renter preferences, etc., while registering on the P2P vehicle sharing platform 106. The renter profile may include renter name, address, bank account details, social security number, and/or the like. The renter vehicle details may include a type of a vehicle associated with (e.g., owned by) the renter, a vehicle brand, model number, color, renter's license, and/or the like.

In some aspects, the renter 110 may submit/send a request to the P2P vehicle sharing platform 106 for renting a vehicle, from the plurality of vehicles 102, when the renter 110 registers on the P2P vehicle sharing platform 106. The request may include, for example, a rent time period (e.g., a time period for which the renter 110 may require the rent vehicle), a travel location (e.g., a location/city/airport name from where the renter 110 may want to rent the vehicle), and/or the like.

Responsive to receiving the rent request, the P2P vehicle sharing platform 106 may determine a set of available vehicles, from the plurality of vehicles 102, and corresponding availability periods. In some aspects, the set of available vehicles may be the vehicles that may be available for rent during the entire rent time period provided by the renter 110.

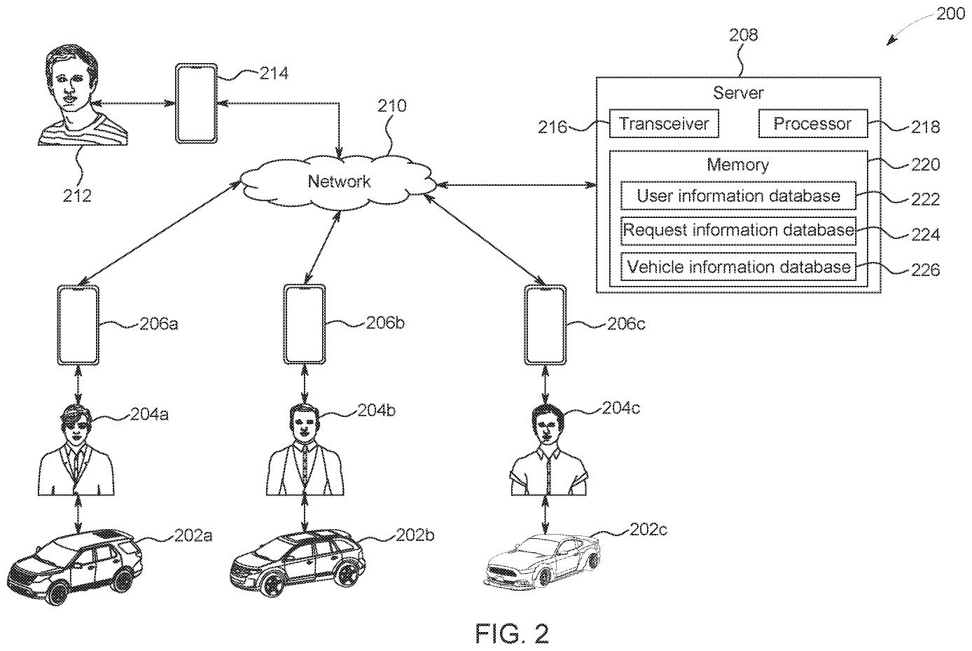

In further aspects, the P2P vehicle sharing platform 106 may select and reserve a vehicle (e.g., the vehicle 102a), from the set of available vehicles, for the renter 110 based on the rent request and a plurality of vehicle details corresponding to the set of available of vehicles. The vehicle selection process details may be understood in conjunction with FIGS. 2-7.

In some aspects, the P2P vehicle sharing platform 106 may transmit notifications to the renter 110 and the owner 108 (on the respective owner and renter devices), when the P2P vehicle sharing platform 106 reserves the vehicle 102a for the renter 110. In one or more aspects, the notification to the owner 108 may include a request from the renter 110, sent via the P2P vehicle sharing platform 106, for vehicle authorization. The P2P vehicle sharing platform 106 may transmit the notification to the owner 108 before and close to a rent time period start date (e.g., 2 days before the rent time period). Responsive to the notification receipt, the owner 108 may approve the request within a predetermined time period (e.g., within 24 hours of notification receipt). In one or more aspect, an agreement for renting the vehicle 102a to the renter 110 may become binding when the owner 108 approves the request.

In some aspects, the notification to the renter 110 may include vehicle identification number (VIN) associated with the vehicle 102a. The P2P vehicle sharing platform 106 may transmit the renter notification before the rent time period start date (e.g., 3 to 5 days before the rent time period) to initiate the request for vehicle authorization, as mentioned above. In one or more aspects, the P2P vehicle sharing platform 106 may transmit the notification to the renter device, so that the renter 110 may view the notification on a renter device display (e.g., display of renter's mobile phone).

On the day of vehicle availability, the owner 108 may park the vehicle 102a at the public place 104 (such as a parking lot of an airport). Further, the owner 108 may send a notification, via the owner device, to the P2P vehicle sharing platform 106 confirming that the vehicle 102a is ready (e.g., available for renting). Furthermore, the owner 108 may provide details of vehicle parking location (such as floor, zone, and/or the like) to the P2P vehicle sharing platform 106. In one or more aspects, the owner 108 may leave a parking ticket inside the vehicle 102a, and may lock the vehicle 102a before leaving the vehicle 102a in the public place 104.

On the day of renting, the P2P vehicle sharing platform 106 may navigate the renter 110 to the vehicle parking location (e.g., by using Global Positioning System on the renter device), when the renter 110 arrives at the public place 104. In addition, the P2P vehicle sharing platform 106 may unlock/open vehicle door when the renter 110 reaches near the vehicle 102a. In some aspects, the P2P vehicle sharing platform 106 may determine that the renter 110 has reached the vehicle location by using GPS and/or based on a renter notification indicating that the renter 110 is near the vehicle 102a.

In some aspects, the vehicle 102a may be communicatively coupled with the P2P vehicle sharing platform 106 via a network (not shown in FIG. 1). The P2P vehicle sharing platform 106 may send a vehicle unlock command to the vehicle 102a, when the renter 110 reaches near the vehicle 102a.

Responsive to vehicle door opening, the renter 110 may set up the renter device (e.g., renter mobile phone) as a key. The renter 110 may then use the vehicle 102a for the rent time period, and may park the vehicle 102a after the rent time period expiries. While leaving the parking, the renter 110 may leave a parking ticket inside the vehicle 102a and may lock the vehicle 102a. The renter 110 may then send, via the renter device, a notification to the P2P vehicle sharing platform 106, informing about the vehicle parking location. Responsive to receiving the renter notification, the P2P vehicle sharing platform 106 may notify the owner 108 that the vehicle 102a is ready to reclaim. Additionally, in some aspects, the P2P vehicle sharing platform 106 may enable a rent payment from the renter 110 to the owner 108 (e.g., via the respective renter and owner bank accounts).

FIG. 2 illustrates a block diagram of an example Peer-to-Peer (P2P) vehicle sharing system 200 (hereinafter referred to as a P2P system 200), in accordance with the present disclosure. The P2P system 200, as described herein, can be implemented in hardware, software (e.g., firmware), or a combination thereof. The P2P system 200 may include a plurality of vehicles 202a, 202b, 202c (collectively referred to as a plurality of vehicles 202) associated with owners 204a, 204b, 204c (collectively referred to as owners 204), respectively. The plurality of vehicles 202 may include, for example, a car, a truck, a sport utility, a crossover vehicle, a van, a minivan, a taxi, a bus, etc., and may be configured and/or programmed to include various types of automotive drive systems.

The owners 204 may register their vehicles, via respective owner devices 206a, 206b, 206c, (collectively referred to as owner devices 206), on a server 208 to share the plurality of vehicles 202 with other registered owners/users. In particular, the owner devices 206 and the server 208 may communicatively couple with each other via a network 210. The owner devices 206 may include, for example, mobile phones, smart phones, mobile nodes, smart watches, scanners, personal digital assistants (PDAs), tablet computers, laptop computers, desktop computers or the like with communication capabilities.

In some aspects, the server 208 may host a P2P vehicle sharing application that may facilitate the owners 204 to share their vehicles with other owners/users registered on the P2P vehicle sharing application. In one or more aspects, the P2P vehicle sharing application may be accessible on the owner devices 206, via the network 210.

The P2P system 200 may further include a renter 212 who may send a request, via a renter device 214, to the server 208 (e.g., to the P2P vehicle sharing application) to rent a vehicle. The renter device 214 may communicatively couple with the server 208 via the network 210Renter device 214 examples are similar to the owner devices 206 examples, described above. In some aspects, the renter 212 may be a vehicle owner as well. For example, the renter 212 may be the owner 204a, 204b, or 204c.

The network 210 may be, for example, a communication infrastructure in which the connected devices discussed in various embodiments of this disclosure may communicate. The network 210 may be and/or include the Internet, a private network, public network or other configuration that operates using any one or more known communication protocols such as, for example, transmission control protocol/Internet protocol (TCP/IP), Bluetooth®, BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples.

The server 208 may be part of a cloud-based computing infrastructure and may be associated with and/or include a Telematics Service Delivery Network (SDN) that provides digital data services to the vehicles 202a, 202b, 202c and other vehicles (not shown in FIG. 2), that may be part of a vehicle fleet.

In accordance with some aspects, the server 208 may include a plurality of components including, but not limited to, a transceiver 216, a processor 218, and a memory 220, which are communicatively coupled with each other. The memory 220 may store programs in code and/or store data for performing various P2P vehicle sharing application operations, in accordance with the present disclosure. Specifically, the processor 218 may be configured and/or programmed to execute computer-executable instructions stored in the memory 220 for performing various P2P vehicle sharing application functions in accordance with the disclosure. Consequently, the memory 220 may be used for storing code and/or data code and/or data for performing operations in accordance with the present disclosure.

In one or more aspects, the processor 218 may be disposed in communication with one or more memory devices (e.g., the memory 220 and/or one or more external databases (not shown in FIG. 2)). The memory 220 can include any one or a combination of volatile memory elements (e.g., dynamic random access memory (DRAM), synchronous dynamic random access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.).

The memory 220 may be one example of a non-transitory computer-readable medium, and may be used to store programs in code and/or to store data for performing various operations in accordance with the disclosure. The instructions in the memory 220 can include one or more separate programs, each of which can include an ordered listing of computer-executable instructions for implementing logical functions.

In accordance with an aspect, the memory 220 may store a plurality of information/dataset in one or more databases. Examples of such databases include, but are not limited to, a user information database 222, a request information database 224, and a vehicle information database 226, which are communicatively coupled to each other.

In some aspects, the transceiver 216 may be configured to receive a plurality of inputs associated with the owners 204 and the renter 212. In some aspects, the owners 204 and the renter 212 may send the plurality of inputs to the transceiver 216 during the registration process on the server 208. For instance, the plurality of inputs associated with the owners 204 may include the plurality of vehicles 202 details, owner details (name, address, bank account details, etc.), and/or the like. The vehicle details may include, for example, vehicle type, brand, model number, color, vehicle insurance documents, and/or the like. In some aspects, the owners 204 may transmit (e.g., by uploading) vehicle pictures and the insurance documents to the transceiver 216.

Similarly, the plurality of inputs associated with the renter 212 may include renter details (name, address, bank account details, etc.), and details of vehicle(s) associated/owned by the renter 110. The renter vehicle details may include vehicle type, brand, model number, color, and renter's license. In some aspects, the renter 212 may upload pictures of his license and other documents to the server 208 (e.g., via the transceiver 216).

In some aspects, the transceiver 216 may be configured to transfer the received plurality of inputs from the owners 204 and the renter 212 to the user information database 222, for storage purpose.

In one or more aspects, the transceiver 216 may be configured to receive vehicle availability information for the plurality of vehicles 202 from the respective owners 204. The vehicle availability information may include information on the days on which the respective plurality of vehicles 202 may be available for rent/sharing. For example, the owner 204a may send the vehicle 202a availability information to the transceiver 216, informing that the vehicle 202a may be available for rent from December 1 to December 10.

Responsive to receiving the vehicle availability information, the transceiver 216 may send the information to the vehicle information database 226, for storage purpose.

In some aspects, the transceiver 216 may be further configured to receive the request from the renter 212, via the renter device 214, to rent a vehicle. The request may include a rent time period (e.g., a time period during which the renter 212 requires the rent vehicle) and travel location. For instance, the renter 212 may send a request to the transceiver 216 to rent a vehicle in Georgia. The renter 212 may indicate that the renter 212 requires the vehicle for fixed dates (for example, for one week from December 1 to December 7).

Responsive to receiving the rent request, the transceiver 216 may send the rent request details to the request information database 224, for storage purpose.

In accordance with further aspects, the memory 220 may be configured to store information associated with the plurality of vehicles 202 in the vehicle information databases 226. In particular, the vehicle information databases 226 may be configured to store the vehicle type, brand, model number, color, and/or the like, associated with the plurality of vehicles 202. In addition, the vehicle information databases 226 may be configured to store vehicle availability information associated with the plurality of vehicles 202 (specifically, availability information associated with each vehicle), as described above.

In accordance with some aspects, the processor 218 may be configured to receive/fetch the plurality of inputs, the rent requests details, and the vehicle information from the memory 220, when the transceiver 216 receives such information. In other words, responsive to receiving the rent request from the renter 212, the processor 218 may be configured to obtain/fetch information stored in the user information database 222, the request information database 224, and the vehicle information database 226.

In one or more aspects, the processor 218 may be configured to obtain a set of available vehicles from the plurality of vehicles 202 from the memory 220 (e.g., from the vehicle information database 226), when the renter 212 sends the rent request to the transceiver 216. In particular, the processor 218 may compare the rent time period (included in the rent request) with the plurality of vehicles 202 availability periods (specifically, availability period associated with each vehicle), and may determine the set of available vehicles that are available during the rent time period. For example, if the rent time period is December 1 to December 7, and the vehicles 202a and 202b are available for rent during the entire rent time period, however the vehicle 202c is not, then the processor 218 may determine the vehicles 202a and 202b as the set of available vehicles for the renter 212.

Responsive to obtaining/determining the set of available vehicles, the processor 218 may be configured to obtain corresponding availability period/information associated with each available vehicle (from the set of available vehicles), from the memory 220. In a scenario, when no vehicle is available during the rent time period, the processor 218 may notify (via the transceiver 216) the renter 212 accordingly. In further aspects, when only one vehicle (e.g., the vehicle 202a) is available, then the processor 218 may reserve the available vehicle for the renter 212, and may transmit a notification to the renter 212 (e.g., on the renter device 214) and the corresponding owner (e.g., on the owner device 206a) that the vehicle 202a is reserved. The notification may be transmitted via the transceiver 216.

In some aspects, when more than one vehicle (e.g., the vehicles 202a and 202b) are available during the rent time period, the processor 218 may be configured to determine and select (e.g., reserve) a best rent vehicle for the renter 212. In some aspects, the processor 218 may select the best rent vehicle based on a rent time period overlap extent with the vehicle availability period, and the plurality of inputs (such as the available vehicles' types and the vehicle type owned by the renter 212). For example, the processor 218 may select the vehicle that has the corresponding vehicle type (e.g., vehicle model) same as a vehicle type owned by the renter 212.

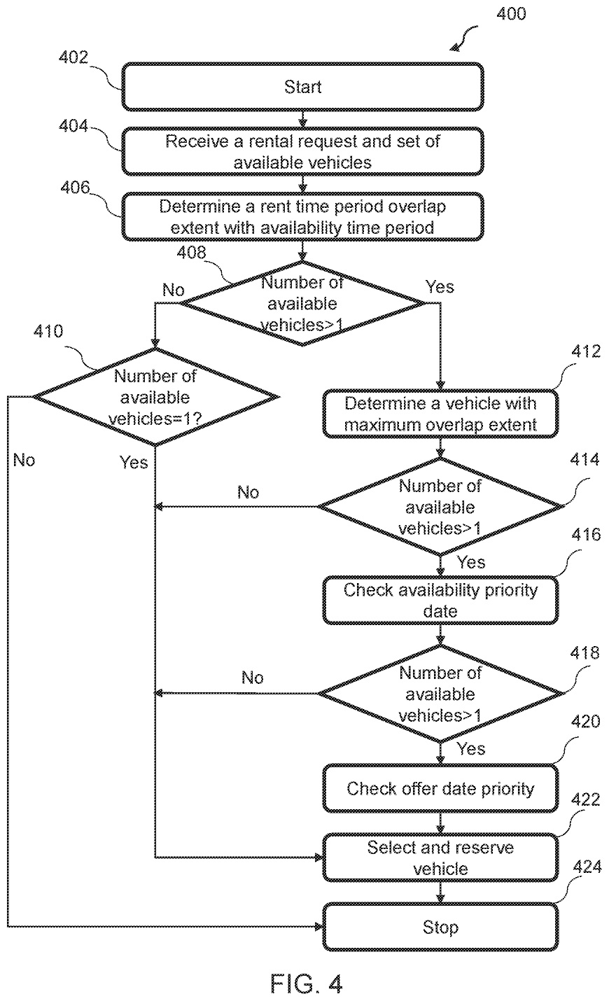

Responsive to determining the best rent vehicle, the processor 218 may sent a notification to the renter 212 and the corresponding vehicle owner. This allows the renter 212 to receive the reservation notification for only one vehicle (e.g., the best match vehicle), and the renter 212 does not have to spend time and effort in selecting/reserving the rent vehicle himself/herself. The process of best rent vehicle determination and selection may be understood in conjunction with FIG. 4.

In accordance with the further aspects, the transceiver 216 may be configured to receive a predefined trigger event, after the rent vehicle reservation for the renter 212. The predefined trigger event may include, for example, receiving a new rent request, a new vehicle entry to the set of available vehicles, rent request withdrawal by the renter 212, or rent vehicle withdrawal by the corresponding owner.

In some aspects, the processor 218 may be configured to receive/fetch the predefined trigger event from the transceiver 216. Responsive to receiving the trigger event, the processor 218 may be configured to activate a rent vehicle reservation re-evaluation for the renter 212. For instance, in a scenario when a new vehicle may be added to the set of available vehicles, the processor 218 may re-evaluate the selection process to determine if the new vehicle is a better match (over the rent vehicle) for the renter 212. In case the processor 218 determines that the new vehicle is a better match, the processor 218 may update the reservation for the renter 212, and transmit the notification to the renter 212 accordingly.

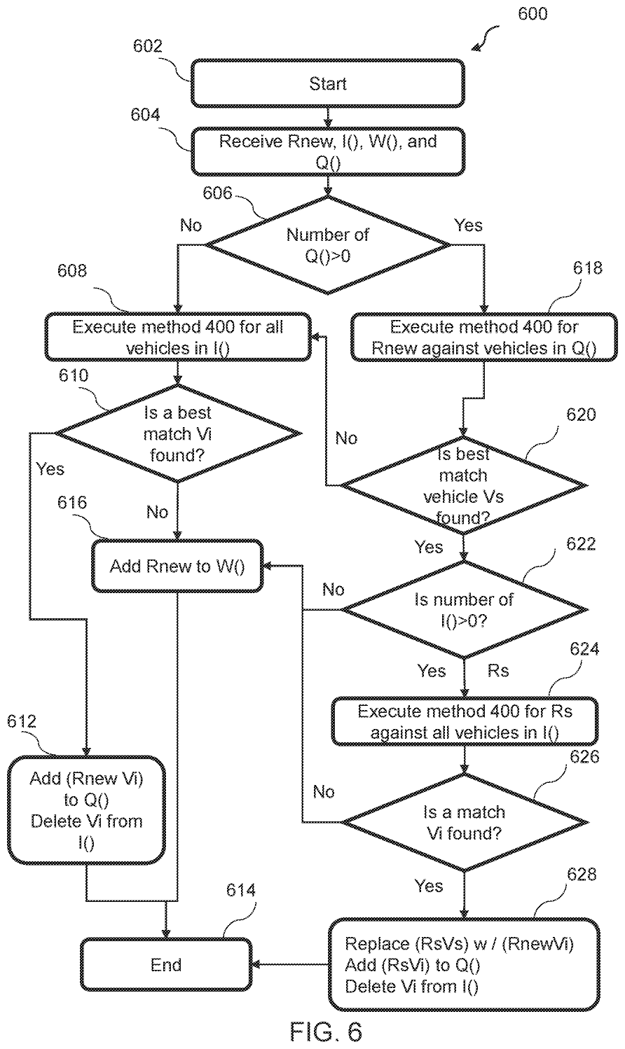

Similarly, the processor 218 may be configured to re-evaluate the reservation for the renter 212 when the transceiver 216 receives a new rent request (from a new renter). For instance, response to receiving the new rent request, the processor 218 may determine if the vehicle reserved for the renter 212 is a better match for the new renter (not shown) associated with the new rent request. In this case, the processor 218 may reserve the rent vehicle for the new renter, and may determine/reserve a new available vehicle for the renter 212. The re-evaluation of vehicle reservation may be understood in conjunction with FIGS. 6-9.

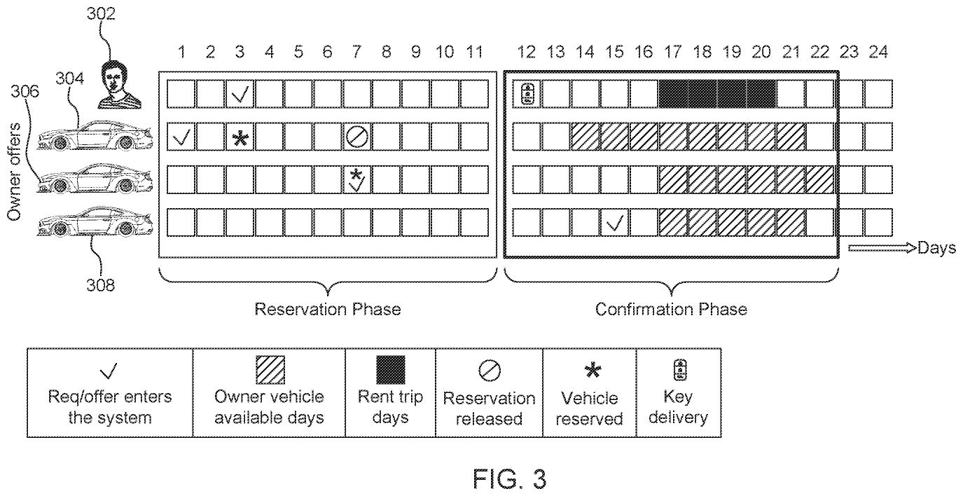

FIG. 3 depicts an example embodiment of renting a vehicle in a P2P vehicle sharing system (e.g., the P2P system 200), in accordance with the present disclosure. In some aspects, an X-axis of FIG. 3 depicts different days, e.g., Day 1, 2, 3 and so on (shown by a plurality of boxes 1-24). Further, a Y-axis of FIG. 3 depicts a renter 302, and a plurality of vehicles (e.g., a vehicle 304, a vehicle 306, and a vehicle 308) that may be available for rent. In particular, FIG. 3 illustrates a two-step process of renting the vehicle, from the plurality of vehicles, by the renter 302. The process may be divided into two phases, e.g., a reservation phase and a confirmation phase.

In the reservation phase, the renter 302 may send a rent request to rent the vehicle for four days, as indicated by Days 17-20 corresponding to the renter 302. The renter 302 may send the rent request on Day 3 to the P2P system 200. As discussed above, responsive to receiving the rent request, the processor 218 may obtain a set of available vehicles for the renter 302.

In the embodiment shown in FIG. 3, a vehicle 304 owner (e.g., a first owner, not shown) may offer to rent the vehicle 304 on the P2P system 200. As indicated in FIG. 3, the first owner may offer the vehicle 304 on Day 1, and the vehicle 304 may be available for rent from Days 14 to 21. Thus, in this embodiment, the processor 218 may determine that one vehicle (e.g., the vehicle 304) may be available for the renter 302. As depicted in FIG. 3, the vehicle 304 may be available for eight days, including the four days for which the renter 302 wants to rent the vehicle. Thus, the processor 218 may reserve the vehicle 304 on Day 3 for the renter 302, and may transmit a notification associated with the reservation to the renter 302 and the first owner. In some aspects, the notification transmitted in the reservation phase may not include the vehicle 304 VIN, and/or the first owner or the renter 302 details, until a confirmation phase start. For example, the notification in the reservation phase may include a message to the renter 302, stating that “A vehicle is reserved for you”, and to the first owner stating that “A renter is assigned for your vehicle”.

In accordance with further aspects, the processor 218 may receive a new vehicle (e.g., the vehicle 306) in the P2P system 200 on Day 7. The vehicle 306 may be available for rent from Days 17 to 22. Responsive to the vehicle 306 receipt, the processor 218 may add the vehicle 306 to the set of available vehicles. As discussed above, responsive to receiving a predefined trigger event (including the addition of a new vehicle), the processor 218 may dynamically re-evaluate the best vehicle match for the renter 302. For instance, the processor 218 may determine a rent time period overlap extent (identified from the rent request) with the set of available vehicles' availability periods, for example, the vehicles 304 and 306, to identify the best vehicle match. For example, in the embodiment depicted in FIG. 3, the processor 218 may determine that the vehicle 306 is a better match over the vehicle 304 for the renter 302, as the overlap extent is 50% for the vehicle 304, and approximately 67% for the vehicle 306. In other words, if the processor 218 reserves the vehicle 304 for the renter 302, then four vehicle 304 available days may not be utilized, and thus the vehicle 304 utilization may not be optimum. On the other hand, if the processor 218 reserves the vehicle 306 for the renter 302, then only two vehicle 306 available days may not be utilized. Thus, the processor 218 may reserve the vehicle 306 for the renter 302, and release the vehicle 304 for other requests/renters. In this manner, the processor 218 may optimize vehicle utilization for the available vehicles in the P2P system 200.

In the scenario described above, the processor 218 may identify a different renter for the vehicle 304, when the processor 218 releases the vehicle 304 reservation. The process of identifying a new renter may be understood in conjunction with FIGS. 6-9.

In accordance with further aspects, the processor 218 may transmit, via the transceiver 216, the vehicle 306 VIN, to the renter 302 (e.g., via a renter device) at a confirmation phase start. In some aspects, the confirmation phase may begin a predetermined number of days (e.g., five days) before a rent time period start (e.g., Day 17). In addition to sending the vehicle 306 VIN, the processor 218 may transmit instructions to the renter 302 to submit a request for vehicle authorization to a vehicle 306 owner. Responsive to the VIN and the instructions receipt, the renter 302 may transmit, via the renter device, the vehicle authorization request to the vehicle 306 owner, via the P2P system 200.

In one or more aspects, responsive to receiving the vehicle authorization request, the vehicle 306 owner may approve the request within a specific time period (e.g., within 24 hours of receiving the request). The agreement of vehicle renting may become binding when the vehicle 306 owner approves the request. At this stage, the processor 218 may transmit a remote key (or a vehicle access code) to the renter 302, via the transceiver 216, so that the renter 302 may use the vehicle 306 during the rent time period.

In some aspects, the processor 218 may fix or finalize the reservation of vehicle 306 for the renter 302 when the agreement becomes binding. In other words, the processor 218 may not re-evaluate (or may deactivate re-evaluation of) the vehicle 306 reservation, when the vehicle 306 is in the confirmation phase. For instance, as depicted in FIG. 3, the vehicle 308 may become available during the confirmation phase, and may offer a better match for the renter 302, over the vehicle 306. However, since the vehicle 306 is already reserved and confirmed for the renter 302, the processor 218 may not re-evaluate the reservation process for the renter 302, even if the vehicle 308 offers a better match (e.g., the vehicle 308 offers 80% overlap with the rent time period).

FIG. 4 depicts a first flow diagram of an example method 400 for selecting a rent vehicle (by the processor 218), in accordance with the present disclosure. The method 400 starts at step 402. At step 404, the method 400 may include receiving a request (Rᵢ) from a renter (e.g., the renter 212) to rent a vehicle. The request may include a rent time period, as described above. In addition, at step 404, the method 400 may include receiving a set of available vehicles (V( )), along with corresponding availability time periods. In some aspects, the processor 218 may receive/fetch the request and the set of available vehicles from the memory 220 and/or from the transceiver 216, as described above.

At step 406, the method 400 may include determining, via the processor 218, a rent time period overlap extent with the set of available vehicles' availability time periods. In particular, at step 406, the processor 218 may determine a number of available vehicles that are available during the days for which the renter 212 needs the rent vehicle. At step 408, the method 400 may include determining if the number of available vehicles is greater than one. If the processor 218 determines that the number of available vehicles is not greater than 1, the method 400 moves to step 410. At step 410, the processor 218 may determine if the number of available vehicles is equal to one. The method 400 moves to step 424 (e.g., the method 400 stops), when the processor 218 determines that there are no available vehicles in the P2P system 200 for the renter 212. In a scenario where the processor 218 determines that the number of available vehicles is equal to one at step 410, the method 400 moves to step 422. At step 422, the processor 218 may select and reserve the available vehicle for the renter 212.

In accordance with further aspects, when the processor 218 determines that the number of available vehicles is greater than one at step 408, the method 400 moves to step 412. At step 412, the method 400 may include determining, via the processor 218, one or more rent vehicles, from all the available vehicles, that offers maximum overlap extent between the availability time periods and the rent time period. In other words, at step 412, the processor 218 may determine one or more vehicles from the available vehicles, which has maximum number of overlapping days (between the rent time period and the availability time periods) in percentage terms.

For example, when the renter 212 generates the request to hire the vehicle in Georgia for the first week of December (e.g., from December 1-7), the processor 218 may identify two vehicles that may be available for the first week of December. A first vehicle may be available from December 1 to 10, and a second vehicle may be available for November 30 to December 7. In this case, at step 412, the processor 218 may determine that the second vehicle availability time period offers the maximum overlap (e.g., 87%) with the rent time period.

At step 414, the method 400 may include determining, via the processor 218, if the number of available vehicles that offer the maximum overlap (determined at step 412) is greater than one. When the processor 218 determines that the number of such available vehicle is not greater than one (e.g., equal to 1), the method 400 moves to step 422. At step 422, the processor 218 may select and reserve the available vehicle for the renter 212. When the processor 218 determines that the number of such available vehicle is greater than one (at step 414), the method 400 moves to step 416.

At step 416, the method 400 may include determining/checking, via the processor 218, available vehicles' availability priority dates. In particular, at step 416, the processor 218 may determine/identify a vehicle whose availability start date is earliest from the number of available vehicles determined at step 412. For instance, when the processor 218 determines that there are two vehicles with overlap percent of 80%, then the processor 218 may determine the availability start dates of both the vehicles. The vehicle with an early availability start date may be considered as the best match for the renter 212. This may be done, as the probability of identifying a new renter for the vehicle with a later availability start date is higher than the vehicle with an earlier availability start date. Therefore, the processor 218 may prioritize the vehicle selection with the earlier availability start date, as the best match for the renter 212.

At step 418, the method 400 may include determining, via the processor 218, whether the number of available vehicles determined at step 416 is greater than one. Specifically, at step 418, the processor 218 may determine if more than one vehicle, identified at step 412, have the same availability start date. If the processor 218 determines that the number of such available vehicles is not greater than one (e.g., equal to 1), the method 400 moves to step 422. At step 422, the processor 218 may select and reserve the available vehicle for the renter 212.

When the processor 218 determines that the number of available vehicles is greater than one at step 418, the method 400 proceeds to step 420. At step 420, the method 400 may include determining/checking, via the processor 218, available vehicles' offer date priority (for the vehicles identified at step 416). Specifically, at step 420, the processor 218 may determine the dates on which the available vehicles' owners offered the vehicles for rent on the P2P system 200. At step 422, the method 400 may include selecting and reserving, via the processor 218, the rent vehicle for the renter 212 that was offered first for rent on the P2P system 200. For instance, if there are two available vehicles having same overlap extent and availability start dates, the processor 218 may determine that vehicle for the renter 212 that may be offered first for rent on the P2P system 200. The method 400 stops at step 424.

In accordance with further aspects (not shown in FIG. 4), the processor 218 may further select a vehicle based on the type of vehicle(s) owned by the renter 212. For instance, when the processor 218 determines that the renter owns a “Ford Mach-E”, the processor 218 may identify and select a “Ford Mach-E” rent vehicle for the renter 212. This is because the renter 212 may be familiar with the features of “Ford Mach-E”, and the rent vehicle owner may also be willing/more comfortable to share his vehicle with a renter who is familiar with vehicle's features. The processor 218 may perform the step of comparing the available vehicles' types with the vehicle type owned by the renter 212 at any method 400 step or stage. For example, the processor 218 may perform the step of comparing (and shortlisting the available vehicles) the vehicle types between steps 404 and 406 of method 400. Alternatively, the processor 218 may perform the step of comparing after step 406, 412, 416 or 420.

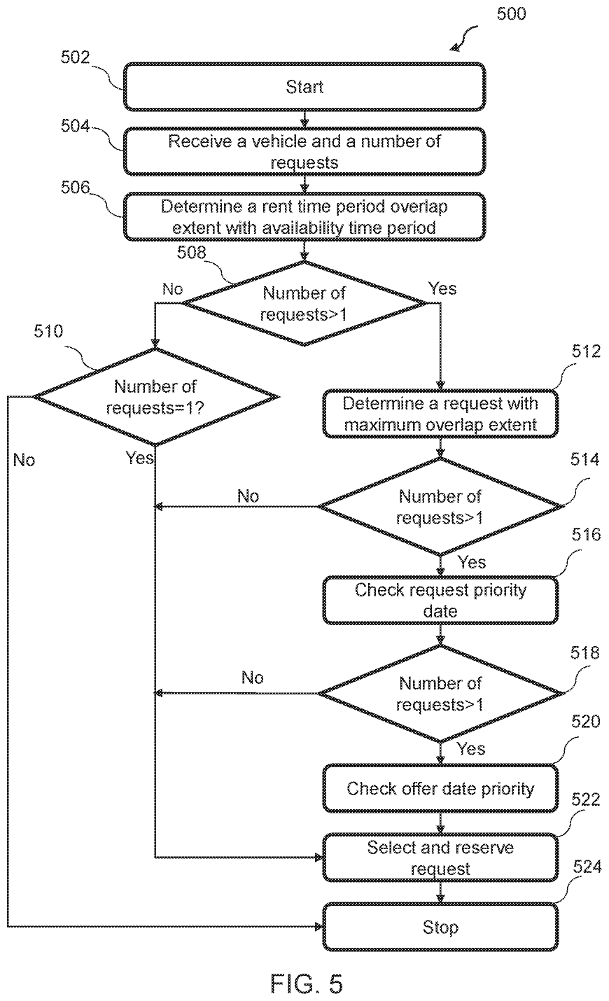

FIG. 5 depicts a second flow diagram of an example method 500 for selecting a request for renting a vehicle, in accordance with the present disclosure. Specifically, FIG. 5 depicts the method 500 for selecting a renter (who may have submitted a rent request to the P2P system 200) for an available vehicle.

The method 500 starts at step 502. At step 504, the method 500 may include receiving, by the processor 218, an available vehicle (Vᵢ) in the P2P system 200, along with number of days the vehicle Vᵢ is available for rent (e.g., an availability time period of Vᵢ). In addition, the method 500 may include receiving a number of requests {Rⱼ} from a plurality of renters, along with the corresponding rent time periods. In some aspects, the processor 218 may receive/fetch the number of requests and the available vehicle Vᵢ availability period from the memory 220 or from the transceiver 216.

At step 506, the method 500 may include determining, via the processor 218, a rent time period overlap extent with the vehicle availability time period. In particular, the processor 218 may determine an overlap between the availability period and the rent time periods associated with all the requests. At step 508, the method 500 may include determining, via the processor 218, if a number of requests for which the rent time period overlaps with the vehicle availability period is greater than one. If the processor 218 determines that the number of requests is not greater than one, the method 500 moves to step 510. At step 510, the method 500 may include determining, via the processor 218, if the number of request is equal to one. The method 500 moves to step 524 when the processor 218 determines that there are no pending requests in the P2P system 200, e.g., when the number of requests identified at step 508 is equal to zero. In a scenario, where the processor 218 determines that the number of request is equal to one at step 510, the method 500 moves to step 522. At step 522, the processor 218 may select and reserve the rent request for the available vehicle.

In accordance with further aspects, when the processor 218 determines that the number of requests is greater than one at step 508, the method 500 moves to step 512. At step 512, the method 500 may include determining, via the processor 218, one or more requests, from all the requests, that offer maximum overlap extent between the vehicle availability time period and the rent time periods. In other words, at step 512, the processor 218 may determine one or more requests, which has maximum number of overlapped days (between the rent time periods and the vehicle availability time period) in percentage terms.

At step 514, the method 500 may include determining, via the processor 218, if the number of requests that offer the maximum overlap (determined at step 512) is greater than one. When the processor 218 determines that the number of such requests is not greater than one (e.g., equal to 1), the method 500 moves to step 522. At step 522, the processor 218 may select and reserve the rent request for the available vehicle. When the processor 218 determines that the number of available requests is greater than one (at step 514), the method 500 moves to step 516.

At step 516, the method 500 may include determining/checking, via the processor 218, request priority dates. In particular, at step 516, the processor 218 may determine/identify a request (or one or more requests) whose rent start date is earliest from the number of requests determined at step 512. The request with an early rent start date may be considered as the best rent request for the available vehicle. This may be done, as the probability of identifying a new vehicle for the request with a later rent start date is higher than the request with an earlier rent start date. Therefore, the processor 218 may prioritize the request selection with the earlier rent start date, as the best request match for the available vehicle.

At step 518, the method 500 may include determining, via the processor 218, whether the number of requests determined at step 516 is greater than one. Specifically, at step 518, the processor 218 may determine if more than one requests, identified at step 412, have the same rent start date. If the processor 218 determines that the number of such requests is not greater than one (e.g., equal to 1), the method 500 moves to step 522. At step 522, the processor 218 may select and reserve the rent request for the available vehicle.

When the processor 218 determines that the number of requests is greater than one at step 518, the method 500 proceeds to step 520. At step 520, the method 500 may include determining/checking, via the processor 218, offer date priority of all the requests identified at step 516. Specifically, at step 520, the processor 218 may determine the dates on which renters submitted the requests on the P2P system 200. At step 522, the method 500 may include selecting and reserving, via the processor 218, the request that was submitted first on the P2P system 200, for the available vehicle. The method 500 stops at step 524.

As described above, the processor 218 may select a best match for a renter or an available vehicle by using the method 400 or the method 500. In accordance with further aspects, the processor 218 may be configured to update reservation until a confirmation is made, typically one or more days before the renter's trip starts. In other words, the processor 218 may be configured to update the reservation in the reservation phase (e.g., until the confirmation phase starts). As described above, the processor 218 may update the reservation when the transceiver 216 or the processor 218 receives the predefined trigger event. The predefined trigger event may include receiving a new rent request, a new vehicle entry in the set of available vehicles, renter request withdrawal, or vehicle withdrawal by the corresponding owner. The details of updating the best match for each predefined trigger event may be understood in conjunction with FIGS. 6-9.

In accordance with some aspects of present disclosure, the method 400 and/or the method 500 may include an additional step of storing and maintaining a list of data to optimize vehicle-to-request matching, (as described in FIGS. 4 and 5) in the memory 220. The list of data may include:
a. A list of available vehicles (in the vehicle information database 226)
   I={Vᵢ, i=1, n}
b. Requests on waiting list (in the request information database 224)
   W={Rⱼ, j=1, m}
c. A list of reservations (in the vehicle information database 226)
   Q={(VₖRₖ), k=1, p}
d. A list of confirmed reservations (in the vehicle information database 226)
   C={(VᵢᵢRᵢᵢ), ii=1, q}

In some aspects, the processor 218 may move a vehicle from the list of reservations to the list of confirmed reservations, when the vehicle reservation is confirmed. As described above, the vehicles in the list of confirmed reservation may not change, even when the predefined trigger events occur.

FIG. 6 depicts a third flow diagram of an example method 600 for updating reservation of a vehicle, in accordance with the present disclosure. In particular, FIG. 6 depicts the method 600 for updating an existing reservation, when a new rent request (R_{new}) is submitted to the P2P system 200. In other words, the method 600 may include the list of reservations “Q” re-evaluation, while maintaining all existing reservations. In other words, for an existing renter, a reserved vehicle may change, but the renter still gets a vehicle for the rent time period. Similarly, for an existing owner (whose vehicle is reserved), the renter may change, but the existing owner still gets a renter for his vehicle.

The method 600 starts at step 602. At step 604, the method 600 may include receiving, via the processor 218, the R_{new}, I( ), W( ), and Q( ), as described above. The processor 218 may receive the R_{new} from the transceiver 216 or from the request information database 224. Similarly, the processor 218 may receive I( ), W( ), and Q( ) from the corresponding memory 220 databases. At step 606, the method 600 may include determining, via the processor 218, if the number of reservations is greater than zero (or whether any reservation exists). When the processor 218 determines that there is no reservation, the method 600 moves to step 608. At step 608, the processor 218 may execute the method 400 (described in conjunction with FIG. 4) for all the available vehicles I( ) to identify a best match vehicle Vᵢ for the request R_{new}.

If a best match vehicle Vᵢ is found at step 610, the method 600 moves to step 612. At step 612, the method 600 may include reserving, via the processor 218, Vᵢ for R_{new}, and adding mapping of R_{new} and Vᵢ to Q( ) The processor 218 may further delete Vᵢ from I( ). In other words, at step 612, the processor 218 may add the mapping of R_{new} and Vᵢ (best matched vehicle) to the list of reservations, and remove Vᵢ from the list of available vehicles (as the vehicle Vᵢ is now reserved). Thereafter, the method 600 moves to step 614, at which the method 600 stops.

In some aspects, if the processor 218 does not find any match for R_{new} at step 610, the method 600 moves to step 616. At step 616, the method 600 may include adding, via the processor 218, the request R_{new} to W( ) (e.g., in the waiting list). Thereafter, the method 600 moves to step 614, at which the method 600 stops.

In further aspects, when the processor 218 determines that the number of reservations is greater than zero (e.g., the reservations exists) at step 606, the method 600 moves to step 618. At step 618, the processor 218 may execute the method 400 (described in conjunction with FIG. 4) for the request R_{new} against all the vehicles in the reservation list Q( ) to identify a best match vehicle. At step 620, the method 600 may include determining, via the processor 218, if a best match vehicle Vₛ is found from the vehicles in the reservation list. If the best match vehicle Vₛ is not found, the method 600 moves to step 608. At step 608, the processor 218 executes the method 400 for all the available vehicles (e.g., I( )), as described above.

In accordance with further aspects of present disclosure, if the processor 218 (at step 620) determines that the already reserved vehicle Vₛ (corresponding to an existing reservation/request Rₛ) is a best match vehicle for the new request R_{new}, the method 600 moves to step 622. At step 622, the method 600 may include determining, via the processor 218, if the number of available vehicles (I( )) is greater than one. In particular, when the processor 218 finds a best match vehicle (Vₛ) for R_{new}, the processor 218 may determine or identify another vehicle from I( ) for the existing request (Rₛ), to check if releasing the vehicle Vₛ is possible and if a new match can be identified for Rₛ from I( )). In a scenario, where the processor 218 determines that there is no available vehicle at step 622, the method 600 moves to step 616, where the request R_{new} is added to the waiting list.

Alternatively, if the processor 218 determines that the number of available vehicles I( ) is greater than one (at step 622), the method 600 moves to step 624. At step 624, the processor 218 may execute the method 400 for the existing request/reservation Rₛ, against all the vehicles in the list of available vehicles I( ). At step 626, the method 600 may include determining, via the processor 218, if a match Vᵢ is identified for Rₛ. If the processor 218 does not identify a match Vᵢ for Rₛ, the method 600 moves to step 616, where the request R_{new} is added to the waiting list.

In a scenario, where the processor 218 determines a match Vᵢ at step 626, the method 600 moves to step 628. At step 628, the method 600 may include replacing (RₛVₛ) with (R_{new}Vₛ), adding (RₛVᵢ) to Q( ), and deleting Vᵢ from I( )). In other words, at step 628, the processor 218 may reserve the reserved vehicle Vₛ for the new request (R_{new}), and reserve vehicle Vᵢ for the existing renter/request Rₛ. In addition, the processor 218 may add mapping of Rₛ and Vᵢ to the list of reservations Q( ), and delete vehicle Vᵢ from the list of available vehicles I( ). The method 600 stops at step 614.

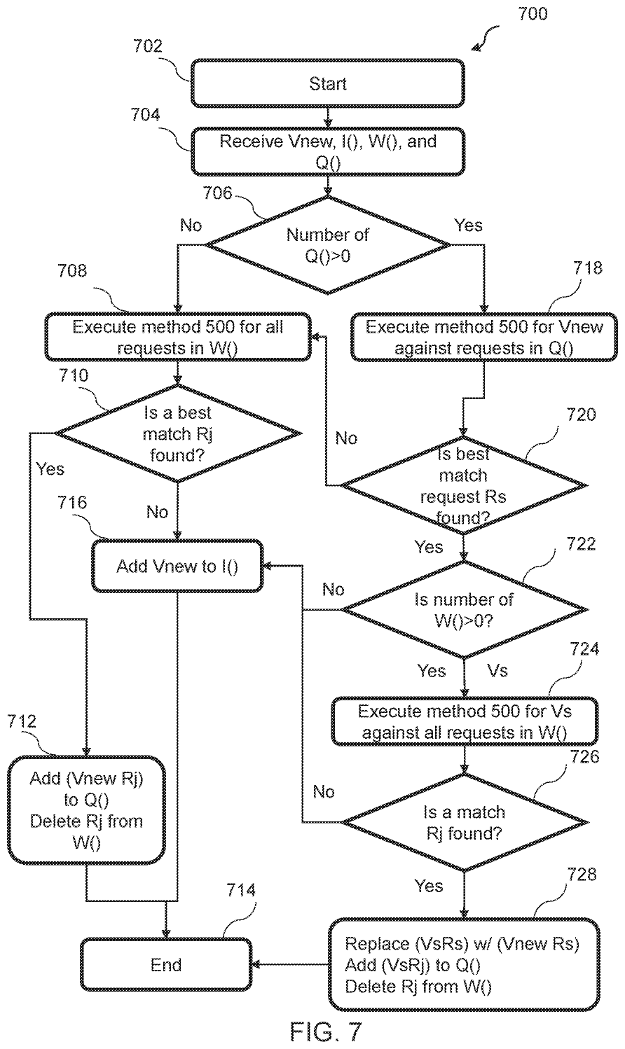

FIG. 7 depicts a fourth flow diagram of an example method 700 for updating reservation of a request, in accordance with the present disclosure. In particular, FIG. 7 describes the method 700 for updating an existing reservation when a new vehicle (V_{new}) is offered for rent on the P2P system 200. In other words, the method 700 includes the “List of reservations Q” re-evaluation, while maintaining all existing reservations. In other words, for an existing renter, a reserved vehicle may change, but the renter still gets a vehicle for the rent time period. Similarly, for an existing owner (whose vehicle is reserved), a renter may change, but the owner still gets a renter for his vehicle.

The method 700 starts at step 702. At step 704, the method 700 may include receiving, via the processor 218, the V_{new}, I( ), W( ), and Q( ). The processor 218 may receive V_{new} from the transceiver 216 or from the vehicle information database 226. Similarly, the processor 218 may receive I( ), W( ), and Q( ) from the corresponding memory 220 databases. At step 706, the method 700 may include determining, via the processor 218, if the number of reservations Q( ) is greater than zero (or whether any reservation exists). When the processor 218 determines that there is no reservation, the method 700 moves to step 708. At step 708, the processor 218 may execute the method 500 (described in conjunction with FIG. 5) for all the requests in the waiting list W( ) to identify a best match request Rⱼ for V_{new}. At step 710, the method 700 may include determining, via the processor 218, if the best match request RR is found for V_{new}. If the processor 218 determines at step 710 that the best match request Rⱼ is found for V_{new}, the method 700 moves to step 712. At step 712, the processor 218 may reserve V_{new} for add mapping of V_{new} and RR to Q( ), and delete RR from W( ). In other words, at step 712, the processor 218 may add the mapping of V_{new} and RR (best matched request) to the list of reservations, and remove the best matched request from the waiting list W( ). The method 700 may then move to step 714, at which the method 700 stops.

In some aspects, if the processor 218 does not find any match at step 710, the method 700 moves to step 716. At step 716, the method 700 may include adding, via the processor 218, the new vehicle (V_{new}) to I( ) (e.g., in the list of available vehicles). The method 700 may then move to step 714, at which the method 700 stops.

In further aspects, when the processor 218 determines that the number of reservations is greater than zero (e.g., the reservations exists) at step 706, the method 700 moves to step 718. At step 718, the processor 218 may execute the method 500 (described in conjunction with FIG. 5) for the new vehicle (V_{new}) against all the requests in the reservation list Q( ) to identify a best match request. At step 720, the method 700 may include determining, via the processor 218, if a best match request Rₛ (an existing request/reservation) is found for V_{new}. If the processor 218 determines that the best match request Rₛ is not found, the method 700 moves to step 708. At step 708, the processor 218 executes the method 500 for all the requests (e.g., W( )).

In accordance with further aspects of present disclosure, if the processor 218 (at step 720) determines that the existing reservation Rₛ (corresponding to a reserved vehicle Vₛ) is a best match request for the new vehicle V_{new}, the method 700 moves to step 722. At step 722, the processor 218 may determine if the number of available requests in W( ) is greater than one. In particular, when the processor 218 determines the best match request (Rₛ) for V_{new}, the processor 218 may determine or identify another request from W( ) for the reserved vehicle (Vₛ), to check if releasing Rₛ is possible and if a new match can be identified for Vₛ from W( ). In a scenario, where the processor 218 determines that there is no available request at step 722, the method 700 moves to step 716, where the new vehicle V_{new} is added to the list of available vehicles.

Alternatively, if the processor 218 determines that the number of available requests is greater than one (at step 722), the method 700 moves to step 724. At step 724, the processor 218 may execute the method 500 for the reserved vehicle Vₛ, against all the requests in the waiting list W( ). At step 726, the method 700 may include determining, via the processor, if a match RR is found for Vₛ. If the processor 218 determines that no match is identified for Vₛ, the method 700 moves to step 716, where the new vehicle V_{new} is added to the list of available vehicles.

In a scenario, where the processor 218 determines a match for Vₛ at step 726, the method 700 moves to step 728. At step 728, the method 700 may include replacing (VₛRₛ) with (V_{new} Rₛ), adding (VA) to Q( ), and deleting RR from W( ). The method 700 stops at step 714.

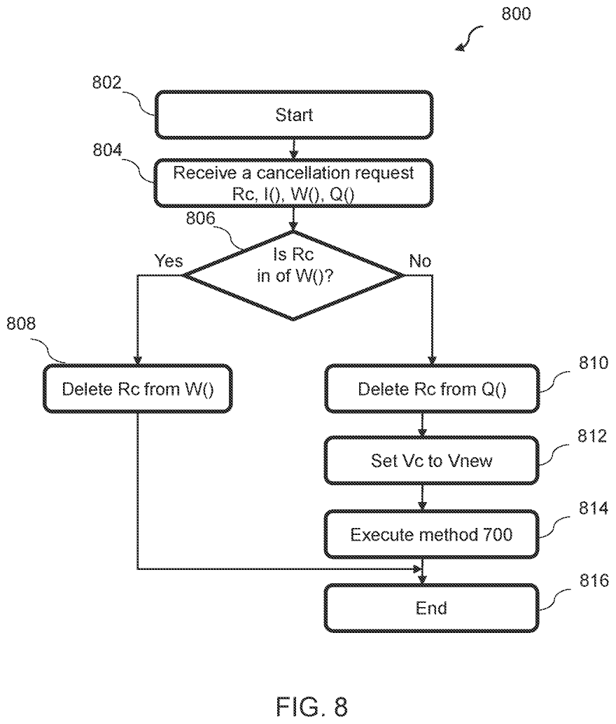

FIG. 8 depicts a fifth flow diagram of an example method 800 for updating reservation of a vehicle, in accordance with the present disclosure. In particular, the method 800 describes a process for updating an existing reservation when a renter cancels a rent request on the P2P system 200. In this case, when a request Rₑ is cancelled, the processor 218 may remove the request from the list W( ), if the request is in the waiting list W( ), On the other hand, if Rₑ is on the reserved list Q( ), the processor 218 may attempt to find a new renter for the reserved vehicle. The process details are discussed below.

The method 800 starts at step 802. At step 804, the method 800 may include receiving, via the processor 218, a cancellation request Rₑ, I( ), W( ), and Q( ). In some aspects, the processor 218 receives the cancellation request Rₑ from the transceiver 216, and I( ), W( ), and Q( ) from the corresponding memory 220 databases. At step 806, the processor 218 may determine if the cancellation request Rₑ is in the waiting list W( ).

Responsive to a determination that Rₑ is in the waiting list W( ), the method 800 moves to step 808. At the step 808, the processor 218 may delete Rₑ from W( ), and the method 800 proceeds to step 816 (at which the method 800 stops).

Alternatively, when the processor 218 determines that Rₑ is not a part of W( ) at the step 806, the method 800 moves to step 810. At this step 810, the processor 218 may delete Rₑ from Q( ). In other words, when the processor 218 determines that Rₑ is already processed and the corresponding vehicle V_{c} is reserved against Rₑ, the processor 218 may cancel the reservation.

At step 812, the processor 218 may set the vehicle V_{c} as V_{new}. In other words, the processor 218 may treat V_{c} as V_{new}, and execute the method 700 at step 814 for V. The method 800 stops at step 816.

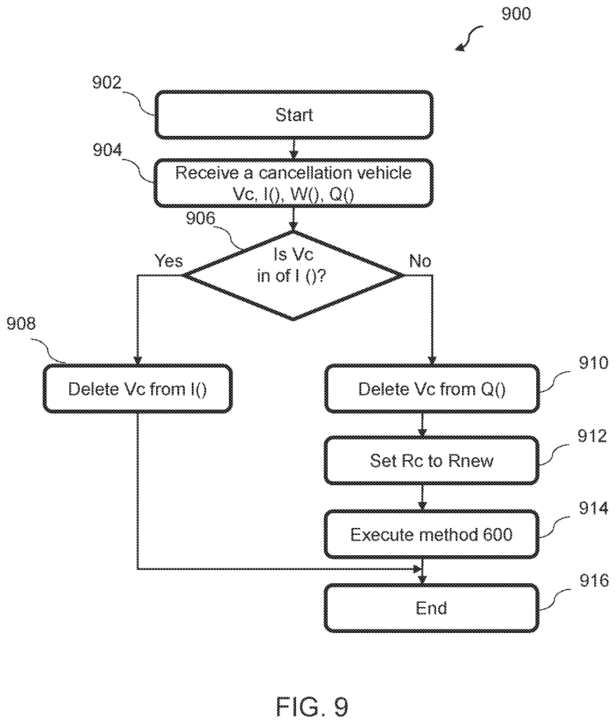

FIG. 9 depicts a sixth flow diagram of an example method 900 for updating reservation of a request, in accordance with the present disclosure. In particular, the method 900 describes a process for updating an existing reservation when a vehicle owner cancels vehicle availability on the P2P system 200. In this case, when a vehicle V_{c} is cancelled, the processor 218 may remove V_{c} from list I( ), if the vehicle is in the inventory/available vehicle list I( ). On the other hand, if V_{c} is on the reserved list Q( ), the processor 218 may attempt to find a new vehicle for the existing renter (for whom V_{c} was reserved). The process details are discussed below.

The method 900 starts at step 902. At step 904, the method 900 may include receiving, via the processor 218, a cancellation request for V_{c}, I( ), W( ), and Q( ). In some aspects, the processor 218 may receive the cancellation request for V_{c} from the transceiver 216, and I( ), W( ), and Q( ) from the corresponding memory 220 databases. At step 906, the processor 218 may determine if the cancelled vehicle V_{c} is in the available vehicle list I( ).

Responsive to a determination that V_{c} is in I( ), the method 900 moves to step 908. At the step 908, the processor 218 may delete V_{c} from I( ), and the method 900 proceeds to step 916 (at which the method 900 stops). Alternatively, when the processor 218 determines that V_{c} is not a part of I( ), the method 900 moves to step 910. At this step 910, the processor 218 may delete V_{c} from Q( ). In other words, when the processor 218 determines that V_{c} is already reserved against a request/reservation Rₑ, the processor 218 may cancel the reservation.

At step 912, the processor 218 may set the request Rₑ as R_{new}. In other words, the processor 218 may treat request Rₑ as R_{new}, and may execute the method 600 at step 914. The method 900 ends at step 916.

In the above disclosure, reference has been made to the accompanying drawings, which form a part hereof, which illustrate specific implementations in which the present disclosure may be practiced. It is understood that other implementations may be utilized, and structural changes may be made without departing from the present disclosure scope. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method for renting a first vehicle, the method comprising:
receiving, via a processor, a first vehicle rental request comprising a rent time period, from a first user device;
receiving, via the processor, a first user input comprising a second vehicle type associated with a first user;
obtaining, via the processor, a set of available vehicles, from a plurality of vehicles, and corresponding availability periods associated with each available vehicle, wherein the set of available vehicles have availability during the rent time period;
determining, via the processor, a rent time period overlap extent with the corresponding availability periods;
selecting, via the processor, the first vehicle from the set of available vehicles based on the rent time period overlap extent and the first user input, wherein a first vehicle availability period has a maximum rent time period overlap extent;
reserving, via the processor, the first vehicle for the first user for the rent time period; and
responsive to the reservation, transmitting, via the processor, a first notification to the first user device and a second user device, wherein the second user device is associated with a first vehicle owner.

2. The method of claim 1, wherein the second vehicle type is same as a first vehicle type.

3. The method of claim 1, wherein the first notification comprises a notification associated with the reservation.

4. The method of claim 1, wherein the first user input further comprises a first user profile, driving license information associated with the first user, and insurance information associated with the first user.

5. The method of claim 1 further comprising:
receiving, via the processor, a predefined trigger event, wherein the predefined trigger event comprises receiving a second rent request, a new vehicle entry in the set of available vehicles, or a first vehicle withdrawal by the first vehicle owner from the set of available vehicles; and
activating, via the processor, a dynamic reservation re-evaluation for the first user, wherein the dynamic reservation re-evaluation comprises determining a third vehicle from an updated available vehicles set, for the first user, and wherein the third vehicle is determined based on the rent time period overlap extent with corresponding availability periods of the updated available vehicles set.

6. The method of claim 5 further comprising providing, via the processor, a remote key to the first user to use the third vehicle, wherein the remote key is provided a predetermined time period before a rent period start date.

7. The method of claim 5 further comprising:
reserving, via the processor, the third vehicle for the first user for the rent time period; and
cancelling, via the processor, a first vehicle reservation for the first user.

8. The method of claim 7 further comprising transmitting, via the processor, a second notification to the first user device and a third user device, wherein the third user device is associated with a third vehicle owner, and wherein the second notification comprises a third vehicle identification information.

9. The method of claim 7 further comprising deactivating dynamic reservation re-evaluation for the first user, when a remote key is provided to the first user.

10. The method of claim 7 further comprising revoking access to a remote key after a rent time period completion.

11. The method of claim 1, wherein selecting the first vehicle from the set of available vehicles further comprises identifying the first vehicle based on available vehicles availability start dates.

12. The method of claim 1, wherein selecting the first vehicle from the set of available vehicles further comprises identifying the first vehicle based on available vehicles rent offer dates.

13. A system for renting a first vehicle, the system comprising:
a processor; and
a memory for storing executable instructions, the processor programmed to execute instructions to:
receive a first vehicle rental request comprising a rent time period, from a first user device;
receive a first user input comprising a second vehicle type associated with a first user;
obtain a set of available vehicles, from a plurality of vehicles, and corresponding availability periods associated with each available vehicle, wherein the set of available vehicles have availability during the rent time period;
determine a rent time period overlap extent with the corresponding availability periods;
select the first vehicle from the set of available vehicles based on the rent time period overlap extent and the first user input, wherein a first vehicle availability period has a maximum rent time period overlap extent;
reserve the first vehicle for the first user for the rent time period; and
responsive to the reservation, transmit a first notification to the first user device and a second user device, wherein the second user device is associated with a first vehicle owner.

14. The system of claim 13, wherein the second vehicle type is same as a first vehicle type.

15. The system of claim 13, wherein the first user input further comprises a first user profile, driving license information associated with the first user, and insurance information associated with the first user.

16. The system of claim 13, wherein the processor is further programmed to execute the instructions to:
receive a predefined trigger event, wherein the predefined trigger event comprises receiving a second rent request, a new vehicle entry in the set of available vehicles, or a first vehicle withdrawal by the first vehicle owner from the set of available vehicles; and
activate a dynamic reservation re-evaluation for the first user, wherein the dynamic reservation re-evaluation comprises determining a third vehicle from an updated available vehicles set, for the first user, and wherein the third vehicle is determined based on the rent time period overlap extent with corresponding availability periods of the updated available vehicles.

17. The system of claim 16, wherein the processor is further programmed to execute the instructions to:
reserve the third vehicle for the first user for the rent time period; and
cancel a first vehicle reservation for the first user.

18. The system of claim 17, wherein the processor is further programmed to execute the instructions to:
provide a remote key to the first user to use the third vehicle, wherein the remote key is provided a predetermined time period before a rent period start date.

19. The system of claim 18, wherein the processor is further programmed to execute the instructions to:
deactivate dynamic reservation re-evaluation for the first user, when the remote key is provided to the first user.

20. A non-transitory computer-readable storage medium having instructions stored thereupon which, when executed by a processor, cause the processor to:
receive a first vehicle rental request comprising a rent time period, from a first user device;
receive a first user input comprising a second vehicle type associated with a first user;
obtain a set of available vehicles, from a plurality of vehicles, and corresponding availability periods associated with each available vehicle, wherein the set of available vehicles have availability during the rent time period;
determine a rent time period overlap extent with the corresponding availability periods;
select a first vehicle from the set of available vehicles based on the rent time period overlap extent and the first user input, wherein a first vehicle availability period has a maximum rent time period overlap extent;
reserve the first vehicle for the first user for the rent time period; and
responsive to the reservation, transmit a first notification to the first user device and a second user device, wherein the second user device is associated with a first vehicle owner.
